(19) United States
(12) Patent Application Publication
(10) Pub. No.: US 2007/0227076 A1
(43) Pub. Date: Oct. 4, 2007

(54) Entry system with water infiltration barrier

(75) Inventor: Michael Braun, Fort Wayne, IN (US)

Correspondence Address: CALFEE HALTER & GRISWOLD, LLP, 800 SUPERIOR AVENUE, SUITE 1400, CLEVELAND, OH, 44114, US

(73) Assignee: Therma-Tru Corp.

(21) Appl. No.: 11/732,186

(22) Filed: Apr. 3, 2007

Related U.S. Application Data
(60) Provisional application No. 60/789,171, filed on Apr. 4, 2006.

(51) Int. Cl. E06B 1/04

(52) U.S. Cl. 49/505

(57) ABSTRACT

The present application discloses embodiments of entry systems that minimize water infiltration due to a wind driven rain. In one embodiment, the entry system includes a corner pad that includes an upper portion that seals against the weather strip when the door is closed and a lower portion that is spaced apart from the weather strip to form a gap between the lower portion and the weather strip. The lower portion seals against the door when the door is closed.

### RELATED APPLICATIONS

This application claims priority from U.S. provisional application Ser. No. 60/789,171 entitled “Entry System With Water Infiltration Barrier,” filed on Apr. 4, 2006. U.S. provisional application Ser. No. 60/789,171 is incorporated herein by reference in its entirety.

### FIELD OF THE INVENTION

The present invention relates to entry systems, particularly entry doorways which are provided with a corner seal to inhibit water filtration.

### BACKGROUND ART

Increased attention is being focused on eliminating or minimizing the water intrusion through entry doors caused by wind driven rain. Referring to prior art FIG. 1, a lower edge 20 of a door 22 can be sealed in a weather tight manner with a sill 24 by a sweep seal 26 mounted on the lower door edge. The vertical junction between the right and left marginal edges of the door face can be sealed to the door jamb by an elongate weather strip 28 affixed to the jamb 30. The right and left lower corners where the sill and door jamb meet form a difficult to seal junction and are a frequent leak site. There have been numerous efforts to seal the door jamb corners. Representative examples of efforts to seal the door jamb corners are shown in U.S. Pat. Nos. 3,851,420; 6,219,971 and 6,665,989.

Rectangular compressible corner pads 32 have been placed on the bottom of the jamb 30 where the jamb meets the sill 24. The rectangular corner pad 32 is compressed between the door 22 and jamb 30 when the door is closed to fill the space between the door and the jamb at the bottom corner of the door, thus inhibiting leakage of water at this location. A portion of the rectangular corner pad 32 extends behind a flexible leg 36 of the weather strip 28. The rectangular corner pad 32 is illustrated in FIGS. 1 and 2 was used by Therma-Tru in this manner at least as early as Aug. 15, 1988. Referring to FIG. 2, the corner pad 32 has a tapered profile with rounded edges. When the door 22 is shut against the weather strip, the weather strip is compressed against the door to form a seal against the door. When the weather strip 28 is compressed, a channel 40 defined by the weather strip is reduced in size.

### SUMMARY OF THE INVENTION

The present application discloses embodiments of entry systems that minimize water infiltration due to a wind driven rain. In one embodiment, the entry system includes a corner pad that includes an upper portion that seals against the weather strip when the door is closed and a lower portion that is spaced apart from the weather strip to form a gap between the lower portion and the weather strip. The lower portion seals against the door when the door is closed.

### BRIEF DESCRIPTION OF THE DRAWINGS

FIG. 1 is a partial perspective view of a lower corner of a prior art entryway system;

FIG. 2 is a sectional view of a corner pad used in the entryway system illustrated by FIG. 1;

FIG. 3 is a partial perspective view of a lower corner of an entryway system utilizing the present invention;

FIG. 4 is a side cross-sectional view of an entryway system taken along lines 4-4 of FIG. 3;

FIG. 5A is a top sectional plan view of the entryway system of FIG. 4 taken along lines 5-5 showing a door in an open position;

FIG. 5B is a top sectional plan view of the entryway system of FIG. 4 taken along lines 5-5 showing the door in a closed position;

FIGS. 6A and 6B are views of an alternate sectional shape of a corner seal;

FIGS. 7A and 7B are right and left side elevational views of a pair of corner seals;

FIGS. 8A and 8B are perspective views of the corner seals illustrated by FIGS. 7A and 7B;

FIG. 9 is a sectional view of embodiment of a corner seal having a generally rectangular cross-section;

FIGS. 10A and 10B are perspective views of corner seals having the cross-section illustrated by FIG. 9;

FIG. 11 is a side view of an embodiment of a corner seal;

FIG. 12 is a side view of an embodiment of a corner seal;

FIG. 13 is a side view of an embodiment of a corner seal;

FIG. 14 is a side view of an embodiment of a corner seal;

FIG. 15 is a side view of an embodiment of a two-piece corner seal;

FIG. 16 is a side view of an embodiment of a two-piece corner seal;

FIG. 17 is a sectional view of an embodiment of a weather strip;

FIG. 18 is a sectional view of an embodiment of a weather strip; and

FIG. 19 is a sectional view of an embodiment of a weather strip.

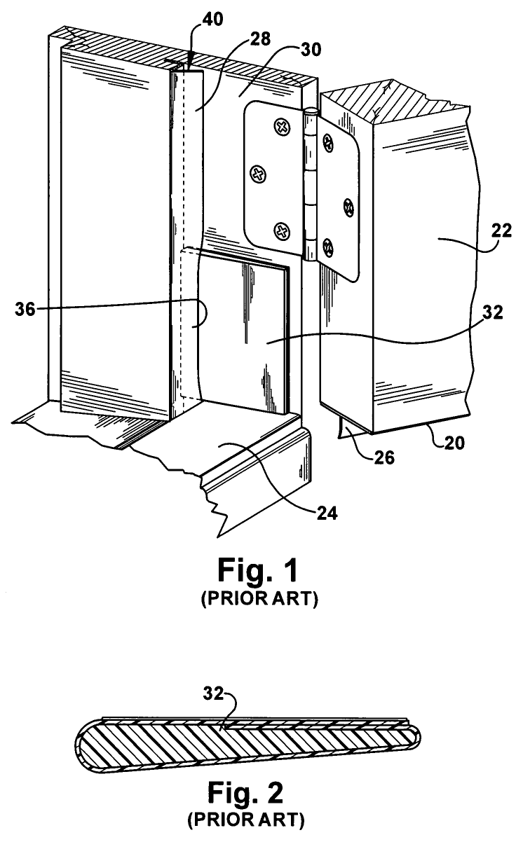

### DETAILED DESCRIPTION OF THE PREFERRED EMBODIMENT(S)

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

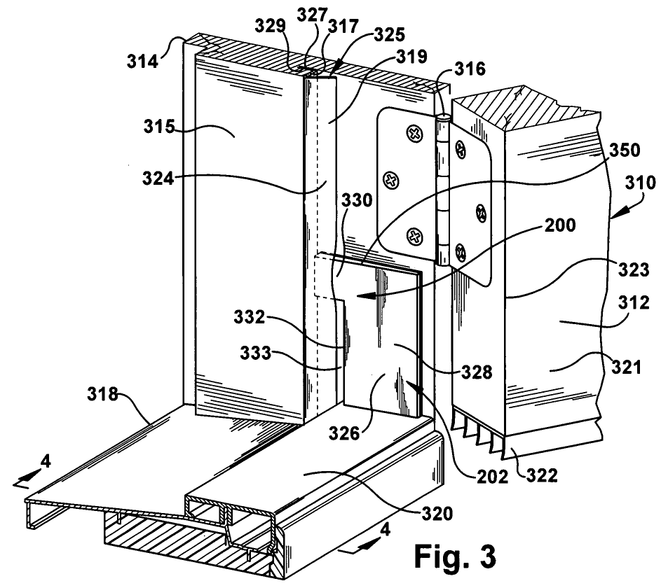

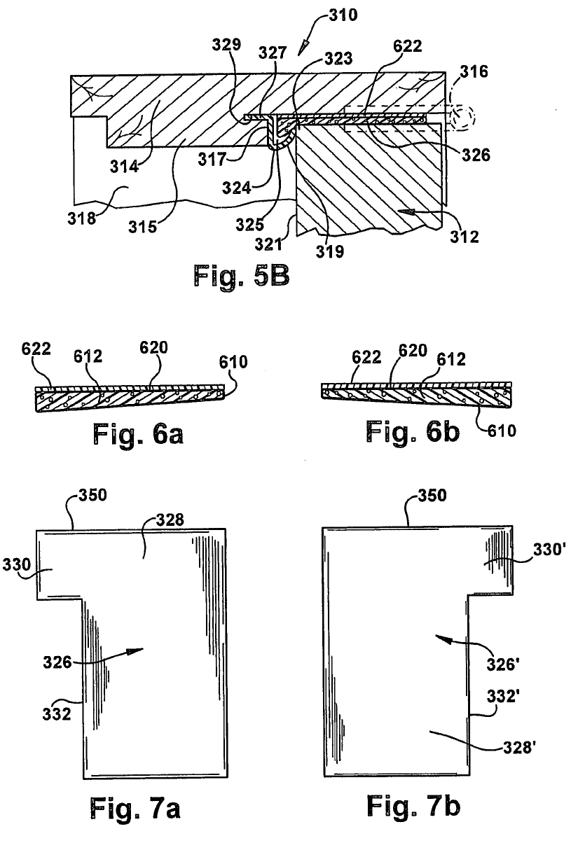

FIGS. 3-5 illustrate a lower corner of an exemplary entryway system 310. In the illustrated embodiment, a hinged door 312 is mounted to a vertical jamb 314 by a conventional hinge 316. The door jamb 314 extends vertically from a sill 318 which is provided with a threshold cap 320 extending from the door jamb 314 to an opposite door jamb (not shown) on the other side of the entryway. The lower marginal edge of door 312 is provided with a sweep seal 322 which sealingly engages the threshold cap 320 when the door is closed. The jamb 314 includes an elongated stop 315. The stop 315 may be integrally formed with the door jamb 314 or the stop 315 may be a separate member that is attached to the doorjamb 314. A weather strip 324 is attached to the jamb 314. The illustrated weather strip includes a first leg 317 that is positioned adjacent to the stop 315 and a second, flexible leg 319. A channel 325 is defined between the first leg 317 and the flexible leg 319. The weather strip 324 may be attached to the jamb 324 in a wide variety of different ways. In the illustrated embodiment, the weather strip 324 is attached by a projection 327 of the weather strip that is secured in a recess 329 that is defined between the stop 315 and the jamb 317. The outer face 321 and/or the outer margin vertical corner edge 323 of door 312 sealingly engages the weather strip 324 when the door is in the closed position (See FIG. 5B). A corner seal 326 is affixed to the door jamb 314 and is located immediately atop of the threshold cap 320 in the illustrated embodiment.

In the embodiment illustrated by FIGS. 3-5, the corner seal 326 seal has an upper portion 200 that seals against the weather strip when the door is closed and a lower portion 202 that is spaced apart from the weather strip to form a gap 333 between the lower portion and the weather strip 324. The lower portion 202 seals against the door 312 when the door is closed.

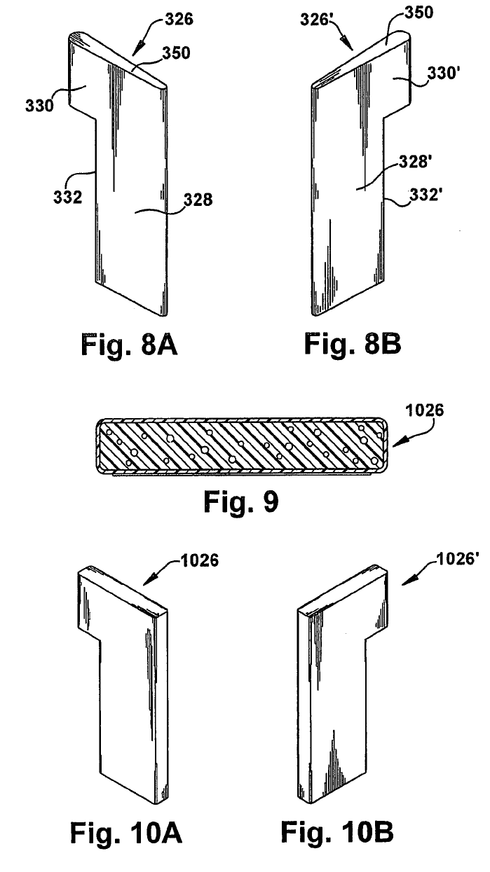

An exemplary corner pad or seal 326 is shown in FIGS. 7A and 8A. The illustrated corner seal 326 is generally shaped like the number “7” or is “L” shaped, depending on the orientation of the seal. The corner seal 326 has a generally, vertically aligned rectangle body 328 with a projection 330 extending therefrom at the upper outer corner. Projection 330 cooperates with weather strip 324 to provide a leak tight seal when the door is closed above the level of wind driven rain. In the exemplary embodiment, the projection 330 and the weather strip 324 are pressed together when the door is closed to provide a leak tight seal therebetween. The projection 330 is preferably over 1″ above the sill and most preferably 2″ to 4″ above the sill.

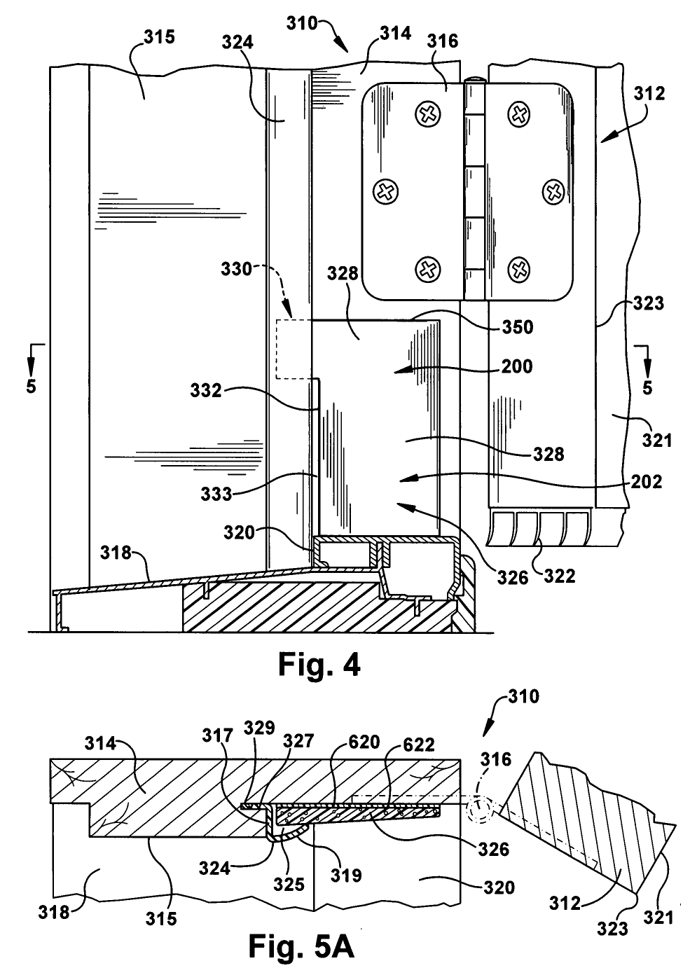

When the door 312 is closed, the channel 325 of the weather strip 324 is reduced in size, creating a small capillary that extends upward along the weather strip. The channel 325 may be reduced to the point that a drop of water can span the channel and wick up the channel by capillary action and/or the water could be forced up the channel by blowing wind. However, an outer marginal edge 332 of corner seal 326 below extension 330 is spaced from weather strip 324 when the door is closed forming a gap 333 (See FIG. 4). The gap 333 may be in communication with the channel 325, such that water in the channel 325 can drain into the gap 333. The gap 333 is too large for a drop of water to bridge across in an exemplary embodiment. As a result, water is inhibited from moving up the channel 325 as a result of capillary action. In another exemplary embodiment, the gap 333 is small enough for a drop of water to bridge, but too large for a drop of water to travel up due to capillary action. These designs inhibit wicking or the upward flow of water between the corner seal and the adjacent section of weather strip 324.

The projection 330 also helps to inhibit water from being pushed over a top edge 350 of the corner seal and into the building. The projection 330 eliminates the gap 333 between the corner seal 326 and the weather strip 319 at the top of the corner seal 326. By eliminating the gap 333 at the top of the corner seal, the velocity at which air can travel up the portion of the weather strip that is below the projection is reduced. The velocity is reduced, because the volumetric rate at which air flows past the projection 330 is the same as the volumetric rate at which air flows below the projection and the cross-sectional area through which the air can flow is smaller at the projection 330 (i.e. no gap, the area of channel 325 only) than it is below the projection (i.e. the area of the gap 333 plus the area of the channel 325). The projection also limits air movement up the weather strip to inhibit water from moving up to the top edge 350 by occupying a small portion of the space between the jamb 314 and the weather strip.

The corner seal 326 can have a wide variety of different cross-sectional shapes. Any shape that is conducive to sealing with the door 312 can be used. Examples of sectional shapes of the corner seal include, but are not limited to rectangular, oval, tapered, triangular, etc. For example, the corner seal 326 may have the cross-sectional shape shown in FIG. 2, shown in FIG. 6A, or shown in FIG. 9. The shapes illustrated by FIGS. 2 and 6A are slight wedge shapes with a thicker end located adjacent the weather strip and the thinner end located toward the building interior. The shape illustrated by FIG. 2 has rounded ends and the shape illustrated by FIG. 6A has more “squared off” ends. The angle of the wedge may be between about 1 to 20 degrees, for example an angle between 2 and 10 degrees, such as 5 degrees. Further, the wedge shape can be defined by multiple angles and/or contours. The wedge shape facilitates easy closing of the door while providing a tight seal between the door and the corner seal. FIGS. 9, 10A and 10B illustrate an embodiment of a corner seal 1026 that is similar to the corner seal 326, except the corner seal 1026 has a rectangular cross-section.

The corner seal may be made of a soft polymeric foam material having a smooth wear-resistant outer surface or skin 610. The skin 610 may be integrally formed or formed by applying a thin film thereto. In one embodiment, a core 612 of the seal is made of an open cell urethane foam and the outer cover or skin 610 is formed of a low friction polyurethane. The invention is not limited to the specific seal material and other materials such as a self skinning closed cell foam could be used.

The corner pad or seal 326 may be coupled to the door jamb 314 in a wide variety of different ways. The corner seal 326 may be coupled to the door jamb 314 in any manner that holds the corner seal 326 in place as the door 312 is being closed and allows the corner seal 326 to form a seal between the door 312 and the jamb 314 when the door is closed. For example, an adhesive may be provided on the door jamb, an adhesive may be provided on the corner seal, a fastener may attach the seal to the jamb, the corner seal may include a projection that extends into a slot or recess in the door jamb, etc. Referring to FIGS. 5A and 6A, an inner surface 620 of the corner seal 326 which is mounted to the door jamb may be provided with an adhesive layer 622 such as a double coated vinyl foam tape having a high bond strength which is available from a variety of sources such as 3-M “double coated vinyl tape, Model No. 44-16”, ADCO “Very high bond acrylic tape, Model AT-1” or Dow Chemical “Foam tape, product code 36736”. The selected tape should have very good adhesion characteristics so that the corner seal does not detach from the jamb during long periods of use.

It should be appreciated that the right and left side of the door will require corner seals which are mirror images of one another. A corner seal 26 is illustrated on the left side of the door when viewed from the building exterior. A corner seal 26′, shown in FIGS. 6B, 7B and 8B will be placed on the right door jamb in a similar manner.

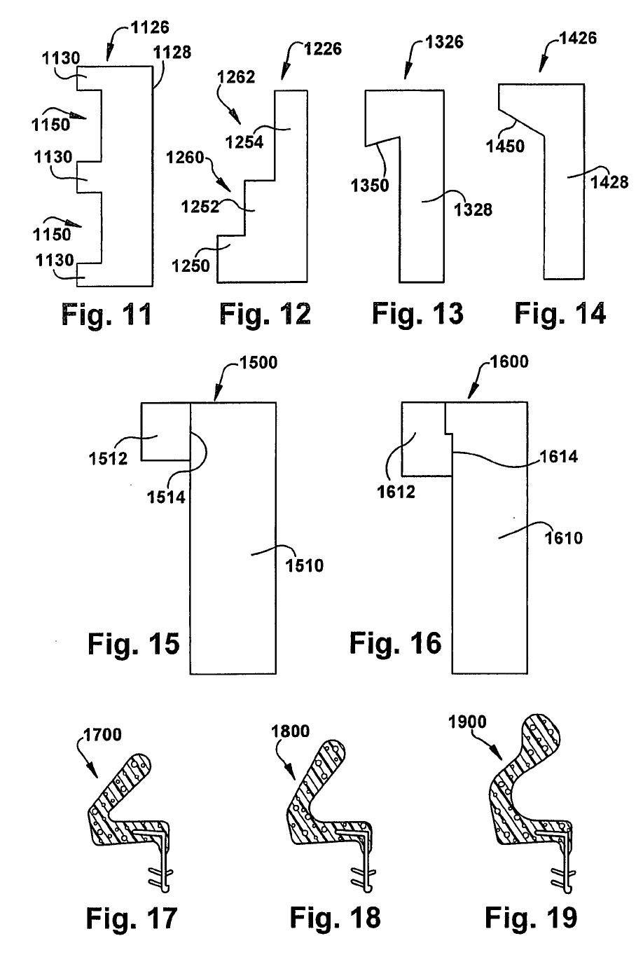

The corner seal can have a wide variety of different profiles. Any profile can be employed that inhibits flow of water up the channel 325 of the weather strip 319 and over the top surface 350 of the corner seal. FIGS. 11-14 illustrate a few of the many possible corner seal profile alternatives. The corner seal 1126 illustrated by FIG. 11 includes a rectangular body 1128 that is similar to the rectangular body 328 of the corner seal 326. The corner seal 1126 includes three projections 1130 that are similar to the projection 330 of the corner seal 326. Any number of projections can be provided. The corner seal 1126 provides two gaps 1150 between the corner seal 1126 and the weather strip to inhibit flow of water up the weather strip channel. Each projection 1130 also inhibits the flow of water up the weather strip channel.

The corner pad or seal 1226 illustrated by FIG. 12 includes a bottom step 1250, a middle step 1252, and a top step 1254. Any number of steps may be provided. The bottom step 1250 seals with the weather strip in the same or a similar manner that the projection 330 of the corner seal 326 seals with the weather strip. The middle step 1252 is spaced apart from the weather strip to form a gap 1260 between the middle step 1252 and the weather strip. The gap 1260 inhibits movement of water up the channel 325 of the weather strip due to capillary action. The top step 1254 is spaced further apart from the weather strip to form a wider gap 1262 between the corner seal 1126 and the weather strip. The wider gap 1262 further inhibits movement of water up the channel 325 of the weather strip due to capillary action. The corner seal 1226 can also be used in an orientation that is inverted from the orientation shown in FIG. 12.

FIGS. 13 and 14 illustrate examples of corner pads or seals 1326, 1426 that are similar to the corner pads or seals 326, except a projection of each corner seal is tapered. The corner seal 1326 includes a projection lower edge 1350 that extends upward as it extends toward a body portion 1328. The corner seal 1426 includes a projection lower edge 1450 that extends downward as it extends toward the body portion 1428. Any of the horizontal or vertical profile edges of any of the corner seals disclosed herein can be angled or contoured to enhance the corner seals ability to keep water from entering the interior of the building.

The projection or projection(s) of the corner pad or seal may be integrally formed with the body of the corner seal. Referring to FIGS. 15 and 16, a corner seal 1500 may comprise two discrete pads or seal members. The corner seal may include a first pad or seal member 1510 configured to seal with the door 312 and a second pad or seal member 1512 configured to seal with the first pad or seal member 1510 and the weather strip 319. In the example illustrated by FIG. 15, a seal line 1514 between the first pad 1510 and the second pad 1512 is straight. The corner pad 1600 is similar to the corner pad 1500, except a seal line 1614 is stepped to further inhibit water from passing between the first pad 1610 and the second pad 1612.

The corner seals described herein can be used with a wide variety of different weather strips. FIGS. 17 through 19 illustrate three examples of weather strips. FIG. 17 illustrates a weather strip 1700 sold by Schlegel under part number TEBD-650. FIG. 18 illustrates a weather strip 1800 sold by Schlegel under part number TEBD-730. FIG. 19 illustrates a weather strip sold by Schlegel under part number TEBD-928.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An entryway comprising:
a vertical door jamb having a bottom end;
a stop extending along the door jamb;
a door hingedly connected to the vertical door jamb;
a weather strip extending along the stop, the weather strip includes first leg that is positioned against the stop and a second leg that seals against the door when the door is closed;
a seal attached to the bottom end of the vertical door jamb, the seal including an upper portion that seals against the weather strip when the door is closed and a lower portion that is spaced apart from the weather strip to form a gap between the lower portion and the weather strip, and wherein the lower portion seals against the door when the door is closed.

2. The entryway of claim 1 wherein the gap is larger than a distance that can be spanned by a drop of water.

3. The entryway of claim 1 wherein the seal has a tapered cross-section.

4. The entryway of claim 1 wherein the seal is attached to the doorjamb with an adhesive.

5. The entryway of claim 1 wherein the seal is formed of a foam polymer material.

6. The entryway of claim 5 further comprising a polymer film that covers the foam polymer material.

7. The entryway of claim 1 further comprising a tape with adhesive on two sides of said tape that adhesively attaches the seal to the door jamb.

8. The entryway of claim 1 wherein the seal has a main generally rectangular body having a generally vertical forward edge and an upper forward corner protrusion which extends from the main body toward the weather strip.

9. The entryway of claim 8 wherein a lower edge of the forward corner protrusion is located at least one inch above a lower edge of the body.

10. The entryway of claim 8 wherein a lower edge of the forward corner protrusion is located above the level of wind driven water.

11. The entryway of claim 8 wherein a lower edge of the forward corner protrusion is located 2 inches to 4 inches above a lower edge of the pad.

12. A corner seal for installation in the lower corner of an entryway door jamb adjacent to the jamb vertical weather strip and directly atop the sill threshold to prevent infiltration of wind driven water, the corner seal comprising:
a thin generally planar body formed of a compressible elastic material sized to sealingly fit between the door jam and the outer periphery of a door when closed, the body having;
a planar mounting face for adhesively mounting to the body to the door jamb adjacent to the weather strip and above the sill threshold;
a forward edge in the region immediately above the sill threshold which is located inboard of the weather strip when the door is closed, the body further having an upward forward edge protrusion which extends outward into engagement with the weather strip to form a substantially tight seal when the door is closed; and
an exposed generally planar face for engaging the door peripheral edge and a lower edge which sealingly abuts the sill threshold when the door is closed.

13. The corner seal of claim 12 wherein the seal body is a mild taper with the body being thicker adjacent the outboard edge proximate the weather strip than the inboard edge.

14. The corner seal of claim 12 wherein the body is formed of a foam polymer material.

15. The corner seal of claim 14 wherein the body further comprises a polymer film covering the foam polymer material which forms an elastic core.

16. The corner seal of claim 12 further comprising a two-sided adhesive layer applied to the body mounting face for adhesively attaching the body to a door jamb.

17. The corner seal of claim 12 wherein the body has a main generally rectangular body member having a generally vertical forward edge and an upper forward corner protrusion which extends from the main body member in the direction of the weather strip.

18. The corner seal of claim 17 wherein the protrusion is located at least one inch above the lower edge of the body so that the protrusion is above the level of wind driven water.

19. The corner seal of claim 17 wherein the lower edge of the protrusion is located 2″ to 4″ above the lower seal edge.

20. An entryway comprising:
a vertical door jamb having a bottom end;
a stop extending along the door jamb;
a door hingedly connected to the vertical door jamb;
a weather strip extending along the stop, the weather strip includes first leg that is positioned against the stop, a second leg that seals against the door when the door is closed, and a channel defined there between;
means for inhibiting wicking of water up said channel.

21. A method providing a seal between a lower end of a door jamb and a lower end of door while inhibiting wicking of water up a channel defined between two legs of a door weather strip comprising:
attaching a corner seal to a door jamb such that a lower portion of the corner seal is spaced apart from the weather strip to form a gap that is too large to span with a drop of water and such that an upper portion of the corner seal engages the weather strip.
